(19) United States
(12) Patent Application Publication
(10) Pub. No.: US 2008/0155357 A1
(43) Pub. Date: Jun. 26, 2008

(54) Structural health monitoring network

(75) Inventors: Zengpin Yu, Palo Alto, CA (US); Chang Zhang, Santa Clara, CA (US); Irene Li, Stanford, CA (US)

Correspondence Address: MACPHERSON KWOK CHEN & HEID LLP, 2033 GATEWAY PLACE, SUITE 400, SAN JOSE, CA, 95110, US

(73) Assignee: Acellent Technologies, Inc.

(21) Appl. No.: 11/543,185

(22) Filed: Oct. 3, 2006

(51) Int. Cl. G06F 11/00

(52) U.S. Cl. 714/47

(57) ABSTRACT

A networked configuration of structural health monitoring elements. Monitoring elements such as sensors and actuators are configured as a network, with groups of monitoring elements each controlled by a local controller, or cluster controller. A data bus interconnects each cluster controller with a router, forming a networked group of “monitoring clusters” connected to a router. In some embodiments, the router identifies particular clusters, and sends commands to the appropriate cluster controllers, instructing them to carry out the appropriate monitoring operations. In turn, the cluster controllers identify certain ones of their monitoring elements, and direct them to monitor the structure as necessary. Data returned from the monitoring elements is sent to the cluster controllers, which then pass the information to the router.

### BRIEF DESCRIPTION OF THE INVENTION

This invention relates generally to structural health monitoring. More specifically, this invention relates to structural health monitoring networks.

### BACKGROUND OF THE INVENTION

Current structural health monitoring systems are designed to carry out diagnostics and monitoring of structures. As such, they typically confer many advantages, such as early warning of structural failure, and detection of cracks or other problems that were previously difficult to detect.

However, these systems are not without their disadvantages. For example, many current structural health monitoring systems are relatively simple systems that have a number of sensors connected to a single controller/monitor. While such systems can be effective for certain applications, they lack flexibility and are often incapable of scaling to suit larger or more complex applications. For instance, a single controller is often unsuitable for controlling the number of monitoring elements (e.g., sensors, actuators, etc.) required to monitor large structures. Accordingly, continuing efforts exist to improve the configuration and resulting performance of structural health monitoring networks, so that they can be more flexibly adapted to different health monitoring applications.

### SUMMARY OF THE INVENTION

The invention can be implemented in numerous ways, including as an apparatus and as a method. Several embodiments of the invention are discussed below.

In one embodiment, a structural health monitoring system comprises a plurality of monitoring clusters, each monitoring cluster having a plurality of monitoring elements each configured to monitor the health of a structure, and a cluster controller in communication with the plurality of monitoring elements and configured to control an operation of the plurality of monitoring elements. The system also includes a data bus in communication with each monitoring cluster of the plurality of monitoring clusters. Furthermore, the cluster controllers are each configured to receive from the data bus control signals for facilitating the control of the monitoring elements, and to transmit along the data bus data signals from the monitoring elements.

In another embodiment, a structural health monitoring network comprises a plurality of monitoring clusters, each monitoring cluster having a plurality of monitoring elements each configured to monitor the health of a structure. The network also includes a router in communication with each monitoring cluster of the plurality of monitoring clusters. The router is configured to select ones of the monitoring clusters, to transmit instructions to the selected monitoring clusters so as to facilitate a scanning of the structure by the selected monitoring clusters, and to receive information returned from the selected monitoring clusters, the information relating to the health of the structure.

In another embodiment, a method of operating a structural health monitoring system having routers each in communication with one or more monitoring clusters, the monitoring clusters each having one or more monitoring elements and a cluster controller in communication with the monitoring elements and the router, comprises receiving instructions to monitor a structure. The method also includes selecting ones of the monitoring clusters according to the instructions. Also included are directing the cluster controllers of the selected monitoring clusters to perform one or more monitoring operations, and receiving from the cluster controllers of the selected monitoring clusters information detected from the one or more monitoring operations.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention, together with further objects and advantages thereof, may best be understood by reference to the following description taken in conjunction with the accompanying drawings in which:

FIG. 1 illustrates an exemplary structural health monitoring network constructed in accordance with an embodiment of the present invention.

FIG. 2 illustrates an exemplary cluster controller for use with the structural health monitoring networks of the invention.

FIG. 3A illustrates a first configuration of a router for use with the structural health monitoring networks of the invention.

FIG. 3B illustrates a second configuration of a router for use with the structural health monitoring networks of the invention.

FIG. 4A illustrates a central controller for use with the structural health monitoring networks of the invention, and configured as a portable computer.

FIG. 4B illustrates a central controller configured as a desktop computer.

FIG. 4C illustrates a central controller configured as a server computer.

Like reference numerals refer to corresponding parts throughout the drawings. Also, it is understood that the depictions in the figures are diagrammatic and not necessarily to scale.

### DETAILED DESCRIPTION OF EMBODIMENTS OF THE INVENTION

In one embodiment of the invention, monitoring elements such as sensors and actuators are configured as a network, with groups of monitoring elements each controlled by a local controller, or cluster controller. A data bus interconnects each cluster controller with a router, forming a networked group of “monitoring clusters” connected to a router. In some embodiments, the router identifies particular clusters, and sends commands to the appropriate cluster controllers, specifying certain monitoring elements and instructing the cluster controllers to carry out the appropriate monitoring operations with those elements. Data returned from the monitoring elements is sent to the cluster controllers, which then pass the information to the router.

The invention also includes embodiments in which each such network (i.e., a group of monitoring clusters and their associated router) is linked over a common data line to a central controller. That is, the central controller is set up to control a number of networks. In this manner, the central controller identifies certain networks for performing structural health monitoring operations, and sends commands to the routers of those networks directing them to carry out the operations. When each router receives these commands, it proceeds as above, directing its monitoring clusters to carry out the monitoring operations and receiving the returned data. The routers then forward this data to the central controller for processing and analysis, sometimes conditioning the signals first. Data returned from the monitoring elements is sent to the routers via the cluster controllers as above, then on to the central controller.

In embodiments of the invention, well-known components such as filters, transducers, and switches are sometimes employed. In order to prevent distraction from the invention, these components are represented in block diagram form, omitting specific known details of their operation. One of ordinary skill in the art will understand the identity of these components, and their operation.

It will also be recognized that the monitoring elements, and at least portions of the local controllers and routers can be affixed to a flexible dielectric substrate for ease of handling and installation. These substrates and their operation are further described in U.S. Pat. No. 6,370,964 to Chang et al., which is hereby incorporated by reference in its entirety and for all purposes. Construction of the substrates is also explained in U.S. patent application Ser. No. 10/873,548, filed on Jun. 21, 2004, which is also incorporated by reference in its entirety and for all purposes. It should be noted that the present invention is not limited to the embodiments disclosed in the aforementioned U.S. patent application Ser. No. 10/873,548. Rather, any network of sensors and actuators can be employed, regardless of whether they are incorporated into a flexible substrate or not.

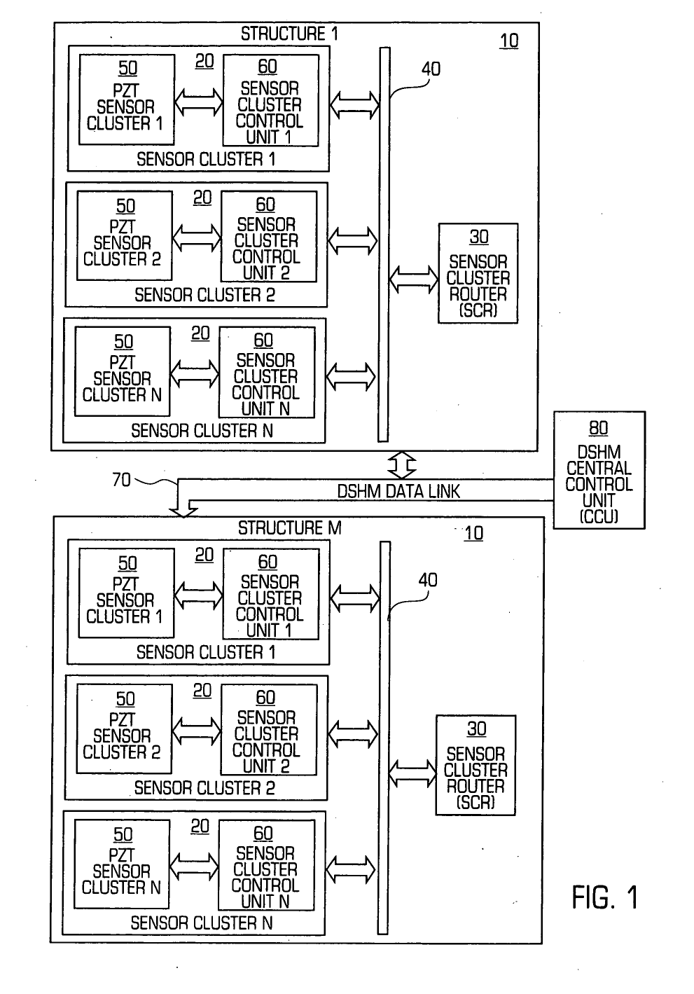

FIG. 1 illustrates an exemplary structural health monitoring network constructed in accordance with an embodiment of the present invention. A number of sensor networks 10 are configured as a group of monitoring clusters 20 and a router 30, interconnected by a data bus 40. Each monitoring cluster 20 has a cluster of monitoring elements 50, such as sensors and/or actuators, controlled by a local controller or cluster controller 60. Each sensor network 10 thus has a number of clusters of sensors, each controlled by a cluster controller 60. The cluster controllers 60 are in turn controlled by a router 30 that selects individual monitoring clusters 20 and transmits instructions to their cluster controllers 60 across the data bus 40.

In operation, the monitoring elements 50 are attached, or otherwise placed in proximity, to a structure so as to monitor its structural health. For example, the monitoring elements 50 can be actuators designed to transmit stress waves through the structure, as well as sensors designed to detect these stress waves as they propagate through the structure. It is known that the properties of the detected stress waves can then be analyzed to determine various aspects of the structure's health.

For ease of use, it is often preferable to place at least portions of the monitoring clusters 20, data bus 40, and router 30 on a flexible dielectric substrate as described above, so as to make fabrication and installation easier. Also, while the invention contemplates the use of any sensors and/or actuators as monitoring elements 50, including fiber optic sensors and the like, it is often preferable to utilize piezoelectric transducers capable of acting as both actuators (i.e., transmitting diagnostic stress waves through a structure) and sensors (detecting the transmitted stress waves). In this manner, a cluster controller 60 can direct certain of the piezoelectric transducers to propagate diagnostic stress waves through the structure, while others of the transducers detect the resulting stress waves and transmit the resulting health monitoring data back to the controller 60. When arranged on a dielectric layer as mentioned above, such networks 10 thus provide distributed networks of monitoring elements 50 that can combine the best features of both active and passive elements, all in a single easy to install dielectric layer.

It should be noted that each network 10 is capable of functioning on its own as an independent distributed structural health monitoring system, actively querying various portions of a structure that it is attached to, and/or detecting stress waves or various other quantities so as to monitor the health of different portions of the structure. All or portions of the network 10 can also be placed on a dielectric layer, making for a network 10 that is easy to manipulate and install.

It should also be noted that other embodiments of the invention exist. Most notably, the invention includes embodiments employing multiple networks 10 whose data buses 40 are each connected by a central data line 70 to a central controller 80. The central controller 80 selects appropriate networks 10 for carrying out monitoring operations, and instructs their routers 30 to carry out monitoring operations (such as actively querying the structure, or detecting stress waves within the structure) by transmitting instructions along the data line 70 and data buses 40. These routers 30 then select appropriate monitoring clusters 20 and initiate the monitoring operations by transmitting instructions to the correct cluster controllers 60 along the data bus 40. The cluster controllers 60 then direct their monitoring elements 50 as appropriate. Data is returned from the monitoring elements 50 to the cluster controllers 60, and forwarded on to the correct router 30. The routers 30 can then condition the data as necessary, perhaps by filtering out undesired frequencies, amplifying the signals, and the like. The data is then passed along the data buses 40 and data line 70 to the central controller 80 for analysis.

One of ordinary skill in the art will realize that the configuration of FIG. 1 confers many advantages. For instance, the system of FIG. 1 can employ multiple networks 10 attached to different parts of a structure, so that multiple different portions of a structure can be analyzed by the same system. Also, as the system of FIG. 1 employs a hierarchy of multiple distributed controllers (i.e., a central controller 80 directs the operation of routers 30, which in turn direct the operation of their associated cluster controllers 60), the system offers flexibility in its operation and update. That is, responsibilities for different portions of the scanning/monitoring process can be distributed among the different controllers. As one example, the central controller 80 can specify not only a scanning operation to be performed, but also more specific information such as the exact monitoring elements 50 that will be used, the scan frequency, and the sampling rate. Alternatively, the central controller 80 can merely request a scan, and allow lower components such as the routers 30 or cluster controllers 60 to specify the details. In addition, as different responsibilities can be located in different components, they can be allocated to those components that are most easily updated. For instance, if the central controller 80 is easily updated while the routers 30 are placed on a remote structure and cannot be easily accessed, much of the responsibility for monitoring can be placed with the central controller 80 so as to make updates as convenient as possible.

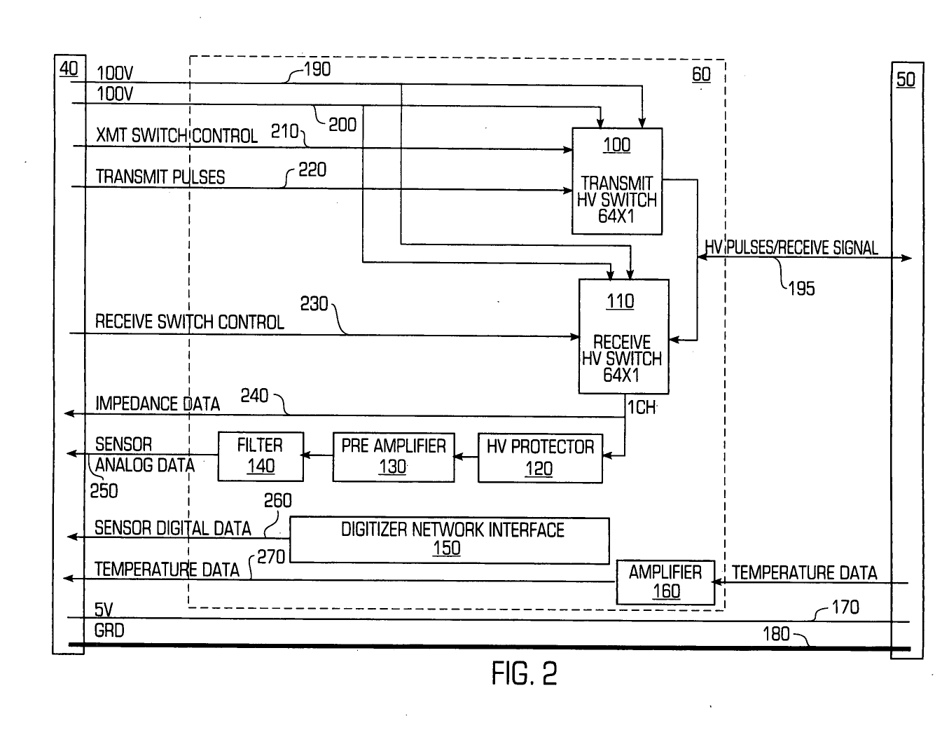

FIG. 2 illustrates an exemplary cluster controller 60 in block diagram form. As above, each cluster controller 60 controls the monitoring elements 50 of a particular monitoring cluster 20. The cluster controller 60 has a high voltage transmit switch 100 and a high voltage receive switch 110 for handling high voltage signals to the monitoring elements 50, as well as a high voltage protector 120, pre-amplifier 130, and filter 140 for conditioning data signals. Optionally, a digitizer 150 can be employed to convert the analog signals to digital data, and an amplifier 160 can be employed to separately amplify signals from temperature sensors, if the monitoring elements 50 include temperature sensors. Note that separate power lines 170 and ground lines 180 can be run between the data bus 40 and monitoring elements 50, if necessary. These lines 170, 180 can be a part of the cluster controller 60 or, as shown, they can be separate lines.

The cluster controller 60 receives control and power signals from its associated router 30 over data bus 40, and transmits data signals back to the router 30 over the same data bus 40. More specifically, when the monitoring elements 50 are actuators, or in other monitoring situations in which the monitoring elements 50 require power, the cluster controller 60 receives power from voltage lines 190, 200 to operate transmit and receive switches. The transmit switch control line 210 and transmit pulse line 220 carry signals from the cluster controller 60 (via the data bus 40) indicating which monitoring elements 50 that the high voltage transmit switch 100 is to close, and when high voltage power pulses are to be sent to those monitoring elements 50, respectively. The receive switch control line 230 indicates which monitoring elements 50 that the high voltage receive switch 110 is to close in order to receive analog signals. The received signals include, but are not limited to, impedance data over an impedance data line 240, and sensor data from those monitoring elements 50 acting as sensors. Sensor data can be sent over an analog data line 250, perhaps after filtering and amplifying by high voltage protector 120, pre-amplifier 130, and filter 140, as is known. Digital data can be transmitted over digital data line 260 after being digitized by digitizer 150.

In operation then, the cluster controller 60 transmits control signals over the transmit switch control line 210 directing the switch 100 to switch on certain monitoring elements 50. If actuation is desired, an appropriate control signal is sent over the transmit switch line 210 directing the transmit switch 100 to allow high voltage pulses over the transmit pulse line 220, to those monitoring elements 50 that have been selected. Power for these pulses is supplied by the cluster controller 60, router 30, or another source. Those monitoring elements 50 convert electrical energy into mechanical stress waves that propagate through the structure to be monitored.

When sensing is desired, such as during detection of mechanical stress waves, the router 30 transmits switch control signals over the receive switch control line 230 directing the receive switch 10 to allow data signals from certain monitoring elements 50. When the monitoring elements 50 is employed as both an actuator and a sensor, typically referred to as pulse echo mode, the high voltage transmit pulses pass through transmit high voltage switch 100 and can also pass through receive high voltage switch 110. In order to prevent these high voltage signals from damaging low voltage electronics components, a high voltage protector 120 is also employed. The received analog signals can be filtered and amplified as necessary. The conditioned signals are then passed back to the router 30 via line 250. If digital data signals are desired, the digitizer 150 can convert the conditioned analog data signals to digital signals, and pass them to the router 30 via line 260. When temperature data is desired, signals from monitoring elements 50 that are configured as temperature sensors are sent to amplifier 160 for amplification as necessary, then passed to router 30 along line 270.

Sensing can also involve previously-unprocessed data. For example, the analog voltage signal received from the monitoring elements 50 can also indicate the impedances of the elements 50. This impedance data can yield useful information, such as whether or not a particular element 50 is operational. As the impedance value of an element 50 is also typically at least partially a function of its bonding material and the electrical properties of the structure it is bonded to, the impedance of an element 50 can also potentially yield information such as the integrity of its bond with the structure.

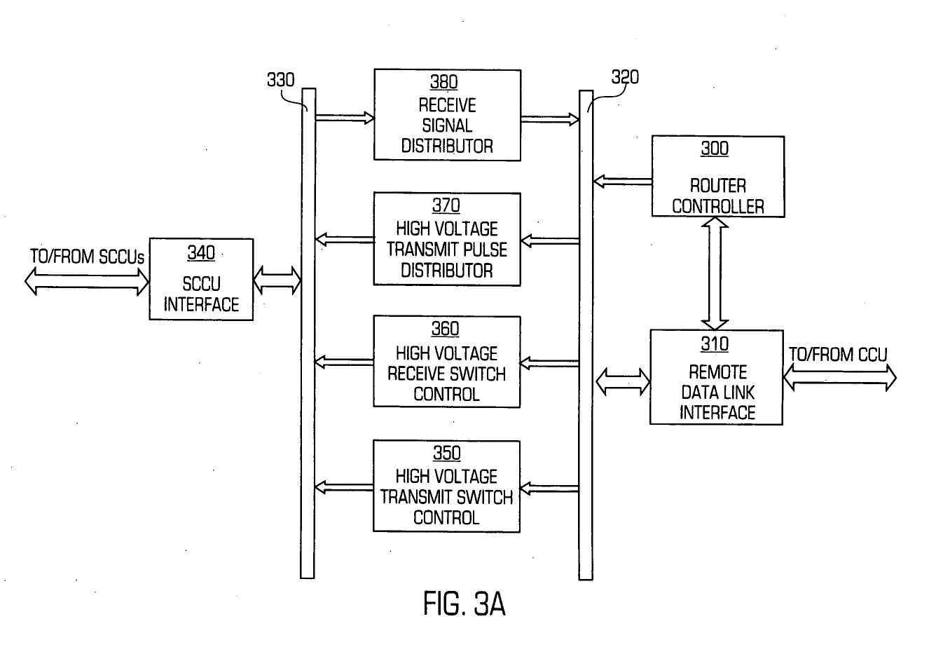

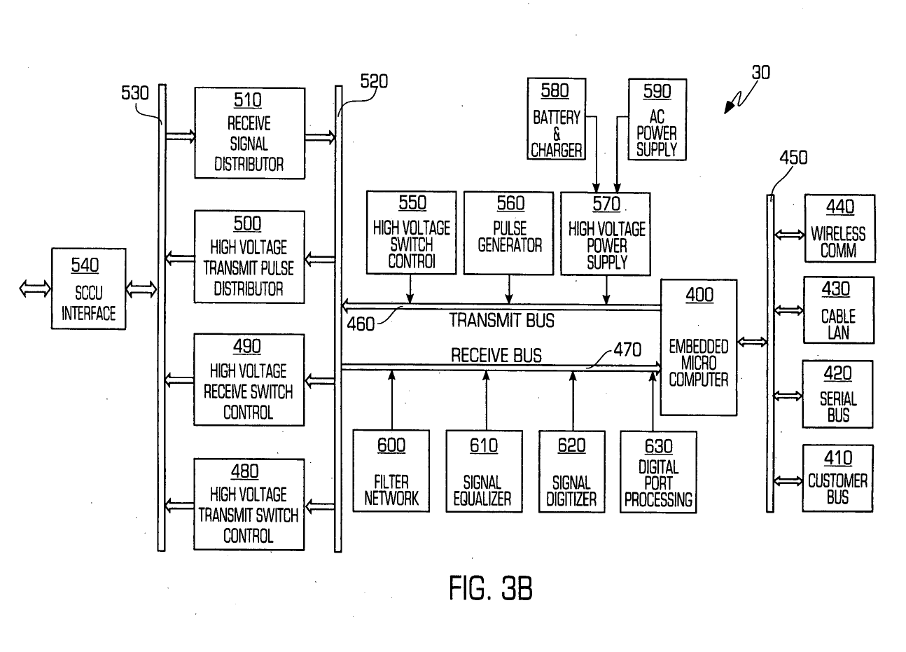

FIG. 3A illustrates further details of a first configuration of a router 30. It is often preferable for the router 30 to perform the functions of selecting the appropriate monitoring clusters 20, and directing control and power signals to those clusters 20 as appropriate. To that end, the router 30 includes a router controller 300 for controlling the operation of the router 30, an interface 310 for interfacing with the central controller 80, internal data buses 320, 330, and a cluster controller interface 340 for interfacing with the various cluster controllers 60. The router 30 also has a high voltage transmit switch controller 350 for instructing cluster controllers 60 to switch on various monitoring elements 50 (i.e., those monitoring elements identified by the router controller 300), and a high voltage receive switch controller 360 for instructing cluster controllers 60 to monitor certain monitoring elements 50 for receiving data signals. The identification of which monitoring elements 50 are to be switched to transmit power, and which are to be monitored for receiving data, can be performed by the router controller 300, in which case the router controller 300 transmits the appropriate commands identifying the monitoring elements 50 to the high voltage transmit switch controller 350 or the high voltage receive switch controller 360, respectively.

The high voltage transmit pulse distributor 370 directs high voltage pulses to the voltage lines 220 when instructed by the router controller 30. The receive signal distributor 380 receives data signals sent from the cluster controller 60 (i.e., data signals sent from the monitoring elements 50 to the receive switch 110, then along the data line 250), and directs them to the interface 310 for forwarding to the router controller 300 or the central controller 80, depending on which unit is responsible for processing gathered data.

In the embodiment of FIG. 3A, the router 30 is responsible for selecting those cluster controllers 60 and associated monitoring elements 50 that will perform monitoring operations, transmitting the appropriate power and control signals to those cluster controllers 60, and receiving any resulting data. In another embodiment, the router 30 also has additional responsibilities, and carries out tasks in addition to those just listed. FIG. 3B illustrates further details of a second configuration of a router 30. In this embodiment, the router 30 includes a router controller 400 for controlling the operation of the router 30, as well as a customer bus 410, serial bus 420, cable LAN 430, and wireless link 440 connected to the router controller 400 via the bus 450 and allowing the router controller 400 to communicate with the central controller 80 as well as other devices. The controller 400 transmits instructions to the cluster controllers 60 over the transmit bus 460, and receives data back from the cluster controllers 60 over the receive bus 470. The cluster controller interface 540, high voltage transmit switch controller 480, high voltage receive switch controller 490, high voltage transmit pulse distributor 500, and receive signal distributor 510 operate as their respective components 340-380, with some exceptions.

First, high voltage switching instructions are provided to the switch controller 490 by a dedicated switch controller 550, and transmit pulse signals for those monitoring elements 50 acting as actuators are supplied to the high voltage transmit pulse distributor 500 by the pulse generator 560. The pulse generator 560 produces any desired pulse signals, such as Sinusoidal waveforms, Gaussian waveforms, and others, using power supplied by the high voltage power supply 570. The high voltage power supply 570 is, in turn, powered by battery 580 or AC power supply 590. The battery 580 and power supply 590 can be located proximate to the network 10 or even, if they are compact and lightweight enough, on the flexible layer. Larger versions of the battery 580 and power supply 590 can also be located remotely.

Second, data signals returned from the receive signal distributor 510 are processed by dedicated components, instead of by the router controller 400 or other components. Such components can execute any processing that facilitates accurate analysis of the data signals. In the embodiment of FIG. 3B, the components include a filter network 600 for filtering undesired frequencies of the data signals (e.g., noise, etc.), and a signal equalizer 610 configured to compensate for distortion in the data signals and/or to provide a variable gain for signals received from each sensing element 50. By applying a variable gain specific to each received sensor signal, the equalizer 610 can variably amplify signals, amplifying those that may be weak, while simultaneously attenuating those that may be too strong. This allows for sensor data of more overall-uniform amplitude. This in turn increases the sensitivity and accuracy of the overall system. The components also include a signal digitizer 620 if digitization of the data signals is desired, and a digital post processor 630 for any desired post processing of the digitized data signals. The presence of such dedicated components 600-630 reduces processing burden on the controller 400 and/or other components, and provides for greater modularity and flexibility in the design of the router 30.

As described above in connection with FIG. 1, the central controller 80 typically instructs other components such as the routers 30 to perform monitoring operations on a structure, and can analyze any resulting data. Partly because the central controller 80 can take on varying responsibilities for handling various aspects of the scanning/monitoring process, the invention encompasses various configurations of the central controller 80. That is, the central controller 80 can be configured as a portable computer, a desktop computer, and a server computer, all in keeping with the invention.

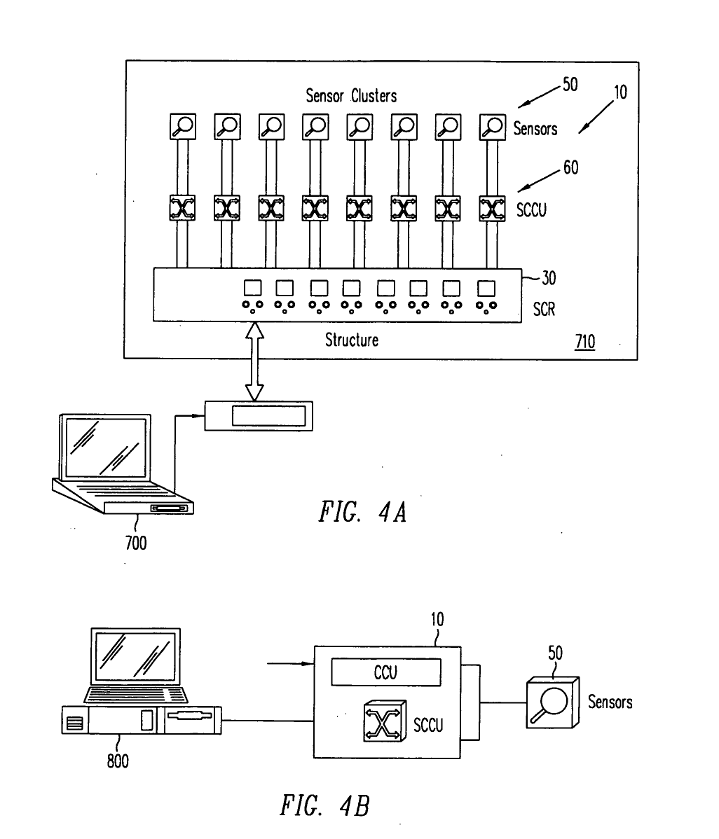

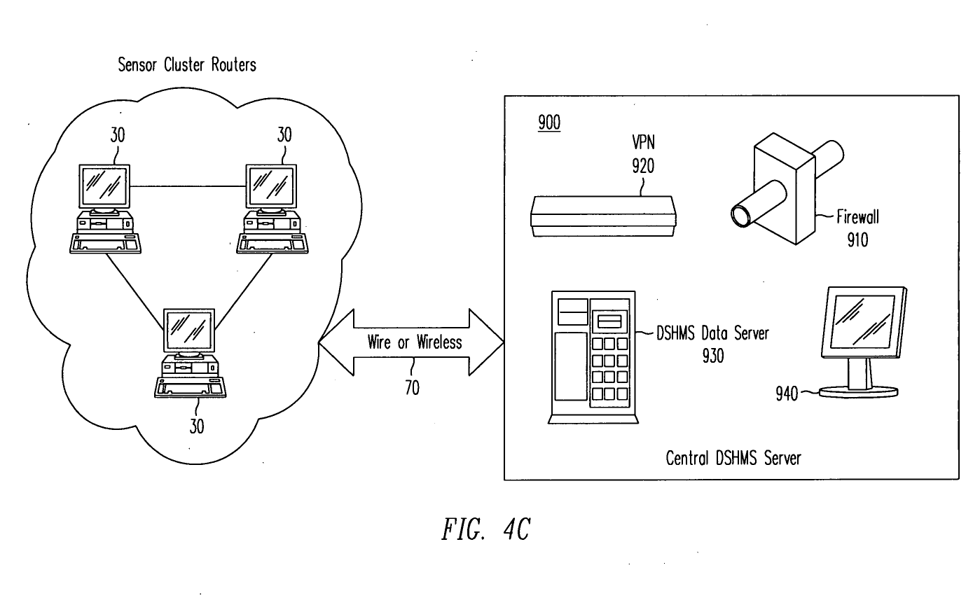

To that end, FIG. 4A illustrates a central controller 80 configured as a portable computer 700. One of ordinary skill in the art will observe that the central controller 80 of the system of FIG. 1 can be incorporated within the portable computer 700, especially in embodiments employing simpler configurations of the controller 80. For example, configuration as a portable computer 700 is often made easier when the central controller 80 delegates execution of many monitoring and/or processing operations to other components such as the routers 30. Such configurations are also made easier when, as in FIG. 4A, only a single structure 710 is monitored with only a single network 10, reducing the processing demand on the portable computer 700. Configuration of the central controller 80 as a portable computer 700 is desirable in many applications, such as when moving structures are monitored. One of ordinary skill will also realize that the central controller 80 can be incorporated within the portable computer 700, or it can be configured as one of any known add-on cards for use with a computer 700.

FIG. 4B illustrates a central controller 80 configured as a desktop computer 800. One of ordinary skill in the art will observe that the desktop configuration of FIG. 4B is desirable in embodiments not requiring portability, or in embodiments requiring greater computing resources than offered by portable computers 700, such as configurations of the controller 80 that take on more duties in the scanning/monitoring process. As with the portable computer 700 configuration above, the central controller 80 can be incorporated within the desktop computer 800, or it can be configured as an add-on card for plugging into the desktop computer 800 (e.g., a controller card that can be plugged into the PCI bus slot of computer 800).

FIG. 4C illustrates a central controller 80 configured as a server computer 900. In this configuration, the server computer 900 can be equipped not only to carry out processing in accord with the invention, but also to employ many other known resources available to current server computers 900. For instance, the server 900 can be equipped with a protective firewall 910, a VPN 920 for securing the network 10 and the resulting data, a data server 930 for carrying out processing of data and storing the results, and monitors 940 for viewing the status of the network 10 and the resulting data. As is known, the server 900 is capable of interfacing directly with data link 70, which can be a wire or a wireless connection. Communication with the routers 30 is performed as described above.

The foregoing description, for purposes of explanation, used specific nomenclature to provide a thorough understanding of the invention. However, it will be apparent to one skilled in the art that the specific details are not required in order to practice the invention. In other instances, well known circuits and devices are shown in block diagram form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed. Many modifications and variations are possible in view of the above teachings. For example, the networks 10 of the invention can be implemented wholly, or partly on flexible dielectric substrates. They can also be affixed directly to a structure, instead of employing such a substrate. Also, the central controllers of the invention, in those embodiments that employ them, can be portable computers, desktop computers, or server computers. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A structural health monitoring system, comprising:
a plurality of monitoring clusters, each monitoring cluster having a plurality of monitoring elements each configured to monitor the health of a structure, and a cluster controller in communication with the plurality of monitoring elements and configured to control an operation of the plurality of monitoring elements; and
a data bus in communication with each monitoring cluster of the plurality of monitoring clusters;
wherein the cluster controllers are each configured to receive from the data bus control signals for facilitating the control of the monitoring elements, and to transmit along the data bus data signals from the monitoring elements.

2. The structural health monitoring system of claim A1 wherein the monitoring clusters and at least a portion of the data bus are configured for attachment to the structure.

3. The structural health monitoring system of claim 1 further comprising more than one said plurality of monitoring clusters and more than one of the data buses, each of the data buses in communication with an associated one of the plurality of monitoring clusters, and each in communication with a common data line.

4. The structural health monitoring system of claim 3 further comprising a central controller in communication with the common data line, the central controller configured to transmit instructions along the common data line and to receive the data signals from the common data line.

5. The structural health monitoring system of claim 4:
wherein each of the pluralities of monitoring clusters has an associated router in communication with the associated data bus, the routers configured to receive the instructions from the associated data buses, to identify ones of the monitoring clusters, to direct the cluster controllers of the identified monitoring clusters to initiate a monitoring of the structure, and to receive structural health information resulting from the monitoring of the structure.

6. The structural health monitoring system of claim 4 wherein the central controller is a portable computer.

7. The structural health monitoring system of claim 4 wherein the central controller is a desktop computer.

8. The structural health monitoring system of claim 4 wherein the central controller is a server computer.

9. The structural health monitoring system of claim 1 further comprising a router in communication with the data bus, the router configured to receive the control signals from the data bus, to identify to the cluster controller certain of the monitoring elements identified by the control signals, and to transmit to the cluster controller power signals facilitating the monitoring of the health of the structure.

10. The structural health monitoring system of claim 9 wherein the router is further configured to receive the data signals from the data bus, to condition the received data signals, and to transmit the conditioned data signals along the data bus.

11. The structural health monitoring system of claim 10 wherein the router is further configured to apply a varying gain to the received data signals.

12. The structural health monitoring system of claim 1 further comprising a flexible substrate configured for attachment to the structure, wherein the plurality of monitoring clusters and at least a portion of the data bus are affixed to the flexible substrate.

13. A structural health monitoring network, comprising:
a plurality of monitoring clusters, each monitoring cluster having a plurality of monitoring elements each configured to monitor the health of a structure; and
a router in communication with each monitoring cluster of the plurality of monitoring clusters, the router configured to select ones of the monitoring clusters, to transmit instructions to the selected monitoring clusters so as to facilitate a scanning of the structure by the selected monitoring clusters, and to receive information returned from the selected monitoring clusters, the information relating to the health of the structure.

14. The structural health monitoring network of claim 13 wherein the plurality of monitoring clusters is configured for attachment to the structure.

15. The structural health monitoring network of claim 13 further comprising more than one said plurality of monitoring clusters and more than one said router, each of the routers in communication with an associated one of the plurality of monitoring clusters, and each of the routers in communication with a common data line.

16. The structural health monitoring network of claim 15 further comprising a central controller in communication with the common data line, the central controller configured to select ones of the routers, and to transmit control signals to the selected routers so as to initiate the scanning by the monitoring clusters of the selected routers.

17. The structural health monitoring network of claim 16 wherein the routers are further configured to receive the control signals, and to transmit the instructions according to the control signals.

18. The structural health monitoring network of claim 16:
wherein each of the monitoring clusters further comprises a cluster controller in communication with the monitoring elements and the router;
wherein the routers are further configured to transmit the instructions to the cluster controllers of the selected monitoring clusters; and
wherein each cluster controller is configured to select ones of the associated monitoring elements, to direct the selected monitoring elements to conduct the scanning of the structure, and to transmit the returned information to the associated one of the routers.

19. The structural health monitoring network of claim 16 wherein the routers are further configured to transmit the returned information to the central controller.

20. The structural health monitoring network of claim 16 wherein the routers are further configured to condition the received information.

21. The structural health monitoring network of claim 20 wherein the routers are further configured to variably amplify the received information.

22. The structural health monitoring network of claim 16 wherein the central controller is a portable computer.

23. The structural health monitoring network of claim 16 wherein the central controller is a desktop computer.

24. The structural health monitoring network of claim 16 wherein the central controller is a server computer.

25. The structural health monitoring network of claim 13 further comprising a flexible substrate configured for attachment to the structure, wherein the plurality of monitoring clusters are affixed to the flexible substrate.

26. A method of operating a structural health monitoring system having routers each in communication with one or more monitoring clusters, the monitoring clusters each having one or more monitoring elements and a cluster controller in communication with the monitoring elements and the router, the method comprising:
receiving instructions to monitor a structure;
selecting ones of the monitoring clusters according to the instructions;
directing the cluster controllers of the selected monitoring clusters to perform one or more monitoring operations;
receiving from the cluster controllers of the selected monitoring clusters information detected from the one or more monitoring operations.

27. The method of claim 26 wherein the directing further comprises:
selecting one or more of the monitoring elements from the selected monitoring clusters; and
directing the selected monitoring elements to perform the one or more monitoring operations.

28. The method of claim 26 further comprising identifying ones of the routers, and transmitting the instructions to the identified ones of the routers.
